(19) United States
(12) Patent Application Publication
(10) Pub. No.: US 2009/0084491 A1
(43) Pub. Date: Apr. 2, 2009

(54) Cementless Tibial Tray

(75) Inventors: Brian A. Uthgenannt, Winona Lake, IN (US); Robert Metzger, Wakarusa, IN (US); Troy W. Hershberger, Winona Lake, IN (US)

Correspondence Address: HARNESS, DICKEY & PIERCE, P.L.C., P.O. BOX 828, BLOOMFIELD HILLS, MI, 48303, US

(73) Assignee: BIOMET MANUFACTURING CORP., Warsaw, IN (US)

(21) Appl. No.: 12/236,992

(22) Filed: Sep. 24, 2008

Related U.S. Application Data
(60) Provisional application No. 60/975,012, filed on Sep. 25, 2007.

(51) Int. Cl. B32B 38/10

(52) U.S. Cl. 156/153

(57) ABSTRACT

The present teachings provide a tibial tray and a method for making the same. According to one example, a substrate having a superior surface can be formed. Porous metal material can be attached onto the superior surface of the substrate. Selected areas of the substrate can be removed to form first features of the tibial tray. Selected areas of the polymer portion can be removed to form second features of the tibial tray.

This application claims the benefit of U.S. Provisional Application No. 60/975,012, filed on Sep. 25, 2007. The entire disclosure of the above application is incorporated herein by reference.

### FIELD

The present teachings relate to tibial trays and methods of manufacture.

### BACKGROUND

Porous metal implants or implants having porous metal portions are used to promote ingrowth of surrounding bony tissue and soft tissues into the implant. When the porosity, integrity and continuity of the metals are sufficient, porous implants serve as a scaffold for tissue ingrowth to provide the desired fixation to host bone. The porous material can be formed by removing pieces from a metal substrate, such as by etching a solid piece of metal. The porous material can also be formed by using small metal particles such as powders.

### SUMMARY

The present teachings provide a tibial tray and a method for making the same. According to one example, a substrate having a superior surface can be formed. Porous metal material can be attached onto the superior surface of the substrate. Selected areas of the substrate can be removed to form first features of the tibial tray. Selected areas of the polymer portion can be removed to form second features of the tibial tray.

According to additional features, attaching the porous metal material can include sintering the porous metal material onto the superior surface of the substrate. Attaching the polymer portion can include molding the polymer portion onto the porous metal material. Removing selected areas of the substrate can include forming portions of a tibial stem. Removing selected areas of the polymer portion can comprise forming a superior surface of the tibial tray including attachment features adapted for selectively securing a bearing.

According to other features, a foil barrier can be attached intermediate the porous metal portion and the polymer portion.

Further areas of applicability of the present teachings will become apparent from the detailed description provided hereinafter. It should be understood that the detailed description and specific examples, are intended for purposes of illustration only and are not intended to limit the scope of the teachings.

### BRIEF DESCRIPTION OF THE DRAWINGS

FIG. 1 is an anterior view of a substrate according to the present teachings;

FIG. 2 is an anterior view of the substrate of FIG. 1 shown with porous metal material attached thereto;

FIG. 3A is an anterior view of the substrate and porous metal material of FIG. 2 and shown with a polymer portion attached thereto;

FIG. 3B is an anterior view of the substrate and porous metal material of FIG. 2 and shown with a polymer portion attached to a foil barrier extending along the porous metal material according to additional features;

FIG. 4 is an anterior view of the substrate, porous metal and polymer member of FIG. 3A and shown with a portion of the substrate removed;

FIG. 5 is an anterior view of a tibial tray constructed in accordance with the present teachings, the tibial tray shown with selected portions of the polymer portion and substrate portion removed to create additional features of the tibial tray;

FIG. 6 is an anterior view of an exemplary knee joint prosthesis including the tibial tray of FIG. 5; and

FIG. 7 illustrates an exemplary sequence of manufacturing the tibial tray of FIG. 5.

### DETAILED DESCRIPTION

The following description is merely exemplary in nature and is in no way intended to limit the teachings, their application, or uses. Although various embodiments may be described in conjunction with a porous metal implant for use with a tibial tray, it is understood that the implants and methods of the teachings can be of any appropriate substrate or shape and can be used with any appropriate procedure and not solely those illustrated.

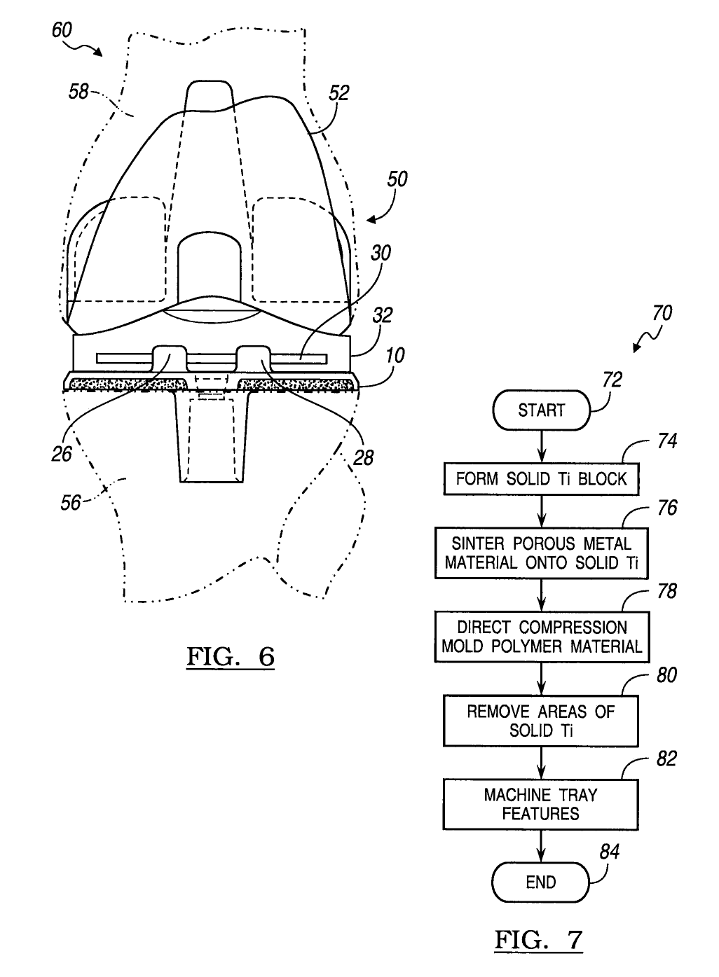

Referring initially to FIG. 5, a tibial tray constructed in accordance with the present teachings is shown and generally identified at reference numeral 10. The tibial tray 10 can generally include a solid metal substrate portion 12, a porous metal portion 14, and a polymer portion 18. As will be described, the tibial tray 10 can be one-piece and formed from a sequential manufacturing process. The tibial tray 10 can provide a porous metal inferior surface 20 conducive to bony ingrowth. The polymer portion 18 can define a superior portion 22 of the tibial tray 10. The tibial tray 10 can include a pair of integrally formed posts 26 and 28, formed by the polymer portion 18, and which extend superiorly at an anterior edge of the tibial tray 10. The posts 26 and 28 can define grooves (not specifically shown) operable to receive a locking bar 30 (FIG. 6) which are able to secure a tibial insert 32 (FIG. 6) to the tibial tray 10 in a manner described below.

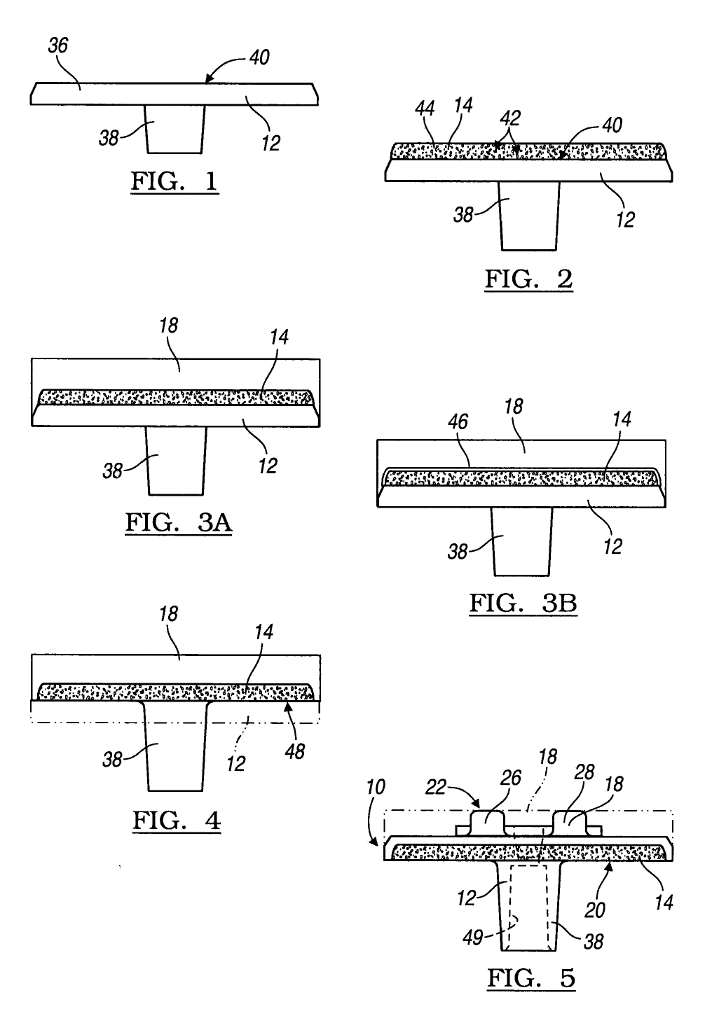

With reference now to FIGS. 1-5, an exemplary method of forming the tibial tray will be described. At the outset, the substrate 12 may be formed having a generally planar upper portion 36 and a cylindrical post portion 38. The substrate 12 can be formed of solid biocompatible material such as, but not limited to titanium. The substrate 12 can be formed into the shape shown in FIG. 1 by any suitable means such as by machining, molding, casting or other methods. As used herein, the term “molding” is used to refer to any molding process, such as, but not limited to, injection molding or (direct) compression molding.

Referring to FIG. 2, the porous metal material 14 can be attached to a superior surface 40 of the upper portion 36. In one example, the porous metal material 14 can be formed from a mixture of a metal powder, a spacing agent (not shown), and a non-polar liquid binder (not shown). The porous metal material 14 can be formed by heating the mixture to a temperature sufficient to remove the spacing agent and non-polar liquid binder thereby leaving a plurality of pores 42 between the interconnected metal powder particles 44.

The porous metal material 14 can be any metal or alloy that is suitable for use as an implant and provides the desired strength, load bearing capabilities, and ability to become porous. Suitable exemplary metals include titanium, cobalt, chromium, or tantalum, alloys thereof, stainless steel, and combinations thereof. The metal powder particles 44 can have a diameter of from about 5 micrometers to about 1500 micrometers. In various embodiments, the metal powder 44 can be of at least two different particle sizes.

The spacing agent can occupy space that gives rise to the pores 42 of the porous metal material 14. The spacing agent can be removable from the mixture and it may be desirable if the spacing agent does not leave residue in the porous metal material 14. It may be further desirable that the spacing agent expands or contracts to supplement the formation of pores 42 of a desired size within the porous metal material 14. The spacing agent can be selected from the group consisting of hydrogen peroxide, urea, ammonium bicarbonate, ammonium carbonate, ammonium carbamate, calcium hydrogen phosphate, naphthalene, and mixtures thereof, or can be any other suitable subliming and space forming material. Generally, the spacing agent can have a melting point, boiling point, sublimation temperature, etc. of about less than 250° C. The spacing agent can provide the macroporosity and microporosity of the biocompatible metal powder before and during the thermal cycling processes, because after the spacing agent decomposes and metallurgical bonds form between the metal powder particles 44, pores (i.e., the pores 42) or gaps remain where the spacing agent was located. One suitable porous metal and method for making may be found in U.S. patent application Ser. No. 11/357,929, filed Feb. 17, 2006, entitled “Method and Apparatus for Forming Porous Metal Implants” owned by Biomet Manufacturing Corp. of Warsaw, Ind., the contents of which are incorporated herein by reference.

Altering the ratios of the mixture components and/or the sizes of the components can provide a porous metal material 14 having a higher or lower porosity, enhanced load-bearing abilities, optimal bone ingrowth abilities and can help to tailor the porous metal material 14 for a particular region of the body (such as a knee according to the instant example). Utilizing a ratio of metal powder to a spacing agent of 8:1 can provide a relatively dense porous metal material 14 having very fine pores. In another example, in a mixture having a 3:1 metal powder to spacing agent ratio, if the spacing agent has a diameter of at least about 25 micrometers and the metal powder has a diameter of about 10 micrometers, large pores result. If the metal powder and spacing agent diameter sizes were reversed, smaller pores would result. It is appreciated that such configurations are merely exemplary and the porous metal material 14 can have any suitable porosity. For example, in embodiments, the porous metal material 14 can include pores ranging in size from about 100 microns to about 600 microns. In embodiments, the size of the pores can average about 300 microns.

The mixture can also include metal powders of different particulate sizes. By including metal powder particulates of at least two different sizes, a porosity gradient can be achieved. The porosity gradient can be such that the porosity of the porous metal material 14 increases or decreases by up to about 80% across the thickness of the porous metal material 14. The porosity gradient can be continuous and scale up (or down) to a desired amount, or the porosity gradient can include differing porosity regions (e.g., 80% porosity region transitions to a 40% porosity region which transitions to a 75% porosity region). The transitions between the regions can be continuous in the porous metal material 14. To provide the different porosities, a mixture corresponding to a particular porosity can be stacked on top of or adjacent to a mixture having a different porosity.

The porous metal material 14 can be attached to the substrate 12 by any suitable means, such as welding, sintering, using a laser, etc. In various embodiments, the substrate 12 can be formed of metal such as the same metal as the porous metal material 14. The temperature and pressure conditions used to attach the porous metal material 14 to the substrate 12 can be such that diffusion and metallurgical bonding between the substrate surface areas and the adjacent porous metal surfaces will be achieved. For example, in an embodiment where the porous metal portion 14 and the metal substrate 12 are heated to 1000° C., the pressure applied must be such that the resultant structure has structural integrity for implanting into a recipient without significant defects.

The substrate 12 can be prepared prior to attaching the porous metal material 14. The substrate 12 can be acid etched, subjected to an acid bath, grit blasted, or ultrasonically cleaned for example. Other preparations include adding channels, pits, grooves, indentations, bridges, or holes to the substrate 12. These additional features may increase the attachment of the porous metal material 14 to the underlying substrate 12.

Additional agents can be coated onto or in at least a surface of the porous metal material 14. Agents include resorbable ceramics, resorbable polymers, antibiotics, demineralized bone matrix, blood products, platelet concentrate, allograft, xenograft, autologous and allogeneic differentiated cells or stem cells, nutrients, peptides and/or proteins, vitamins, growth factors, and mixtures thereof, which would facilitate ingrowth of new tissue into the porous metal material 14. For example, if the additional agent is a peptide, an RGB peptide can be advantageously incorporated into the porous metal material 14.

Turning now to FIG. 3A, the polymer portion 18 may be attached to the porous metal material 14. In one example, the polymer portion 18 may be molded into the porous metal material 14. According to one example, the polymer portion 18 can include polyetheretherketone (PEEK) and/or carbon fiber reinforced PEEK (CFR-PEEK). According to additional features, a foil barrier 46 (FIG. 3B) may be provided intermediate the polymer portion 18 and the porous metal material 14. The foil barrier 46 can be separately formed and disposed onto the porous metal material 14. In another example, the upper superior surface of the porous metal material 14 can be smoothed out or “smeared”, such as by a machining operation to remove or substantially remove any porosity from the superior surface of the porous metal material 14. In another example, the polymer portion 18 can be molded or machined separately and subsequently attached to the superior surface of the porous metal material 14 or to the foil barrier 46. Further, in embodiments, the foil barrier 46 may be located within the porous metal material 14, thereby allowing the polymer portion 18 to mold into the porous metal material 14 while also preventing the polymer portion 18 from molding completely through the porous metal material 14.

Next, with reference to FIG. 4, a portion of the substrate 12 substantially corresponding to the upper portion 36 is removed. In one example, the substrate 12 may be machined away revealing the porous metal portion 14 on an inferior surface 48. With reference now to FIG. 5, the final features of the tibial tray 10 are formed. In one example, an area of PEEK 18 is removed (such as machined away, etc.) to form the posts 26 and 28. Likewise, a female taper 49 may be formed on the post portion 38. Other features not specifically shown may be machined, lasered or otherwise created on the tibial tray 10. In one alternate example, the substrate 12 including the polymer portion 18 and the post portion 38 (and optionally the final features such as the posts 26 and 28, etc.) can be initially formed. Next, the porous metal material 14 can be separately formed. The porous metal material 14 can subsequently be coupled to the substrate by any suitable method. In one example, the porous metal material 14 can have an aperture formed centrally therethrough for receiving the post portion 38 during an assembly step. In one implementation, the aperture can be tapered for cooperatively mating with the outer tapered geometry of the post portion 38 such as in a Morse taper connection.

With reference to FIG. 6, the tibial tray 10 is shown in an implanted position as part of a knee joint prosthesis 50. The knee joint prosthesis 50 can include the tibial tray 10, the bearing 32, and a femoral component 52. The knee joint prosthesis 50 is functionally depicted as being secured to a tibia 56 and a femur 58 of a surgically resected knee joint 60. In one example, the tibial tray 10 can be cementless. The post 38 of the tibial tray 10 can be inserted into an opening made by the surgeon in the longitudinal center of the tibia 56. The bearing 32 can define complementary recesses (not specifically shown) adapted to receive the posts 26 and 28 of the tibial tray 10. Another recess (not specifically shown) may be formed on the bearing 32 for aligning with the grooves on the first and second posts 26 and 28 so as to receive the locking bar 30. It is appreciated that the tibial tray 10 can be formed and/or adapted for use with any kind of knee replacement such as a posterior stabilized (PS) knee, crutiate retaining (CR) knee, hinged knee, fixed knee and others.

An exemplary method of forming the tibial tray 10 is referred to generally at reference 70 in a flow diagram shown in FIG. 7. The method 70 begins in step 72. In step 74, the substrate 12 is formed such as from a solid block of titanium. In step 76, the porous metal material 14 is sintered onto the substrate 12. In step 78, the polymer material 18 can be molded onto the porous metal material 14. In step 80, areas of the substrate 12 can be removed. In step 82, features of the tray 10 can be formed into the polymer material 18 and/or the porous metal material 14. The method ends in step 84.

According to an additional method, the porous metal material 14 may be sintered into a shape without requiring a substrate (i.e. such as substrate 12). In one example, the cylindrical post portion 38 can be formed of porous metal material 14. Next, the polymer material 18 can be molded onto the porous metal material 14. The features of the tray can then be machined into the polymer material 18 and/or the porous metal material 14. In another method of forming the tibial tray 10, the substrate 12 can be molded or machined separately from the porous metal material 14. The two pieces can then be joined by way of a thermal expansion process followed by a cooling retraction process. In one example, at least one of the substrate 12 and the porous metal material 14 can be heated. The substrate 12 can then be placed onto the porous metal material 14 and at least one of the substrate 12 and the porous metal material 14 are cooled (and/or left to return to an ambient temperature). Interlocking features (not specifically shown) formed on the substrate 12 and/or the porous metal material 14 can initially expand (from the heating process) and subsequently contract (from cooling) ultimately interlocking the substrate 12 and the porous metal material 14. One method of such a process is discussed in detail in commonly owned U.S. patent application Ser. No. 12/038,570, filed Feb. 27, 2008, the disclosure of which is expressly incorporated herein by reference.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, the specification and the following claims.

What is claimed is:

1. A method of making a tibial tray, the method comprising:
forming a substrate having a superior surface;
attaching porous metal material onto the superior surface;
attaching a polymer portion onto the porous metal material;
removing selected areas of the substrate to form first features of the tibial tray; and
removing selected areas of the polymer portion to form second features of the tibial tray.

2. The method of claim 1 wherein attaching the porous metal material comprises sintering the porous metal material onto the superior surface of the substrate.

3. The method of claim 1 wherein attaching the polymer portion comprises molding the polymer portion onto the porous metal material.

4. The method of claim 1 wherein removing selected areas of the substrate comprises forming portions of a tibial stem.

5. The method of claim 1 wherein removing selected areas of the substrate comprises exposing at least portions of the porous metal material.

6. The method of claim 1 wherein removing selected areas of the polymer portion comprises forming a superior surface of the tibial tray including attachment features adapted for selectively securing a bearing.

7. The method of claim 1, further comprising attaching a foil barrier intermediate the porous metal material and the polymer portion.

8. A method of making a tibial tray, the method comprising:
forming a substrate having a superior surface;
attaching porous metal material to the superior surface;
forming a non-porous layer on the porous metal material;
attaching a polymer portion to the non-porous layer; and
removing selected areas of the substrate to form first features of the tibial tray.

9. The method of claim 8 wherein attaching the porous metal material comprises sintering the porous metal material onto the superior surface of the substrate.

10. The method of claim 8 wherein attaching the polymer portion comprises heating at least one of the polymer portion and the porous metal material, placing the polymer portion onto the porous metal material, and cooling at least one of the polymer portion and the porous metal material.

11. The method of claim 8 wherein removing selected areas of the substrate comprises forming portions of a tibial stem.

12. The method of claim 8 wherein removing selected areas of the substrate comprises exposing at least portions of the porous metal material.

13. The method of claim 8 wherein forming the non-porous layer includes attaching a foil barrier onto the porous metal material.

14. A method of making a tibial tray, the method comprising:
forming a titanium substrate having a first superior surface;
attaching porous metal material to the first superior surface by applying at least one of heat and pressure to at least one of the substrate and porous metal material, the porous metal material having a second superior surface;
molding polyetheretherketone (PEEK) onto the second superior surface;
removing selected areas of the substrate to form a stem; and
removing selected areas of the PEEK to form attachment features that are configured to selectively secure a bearing and to expose at least one portion of the porous metal material.

15. The method of claim 14 wherein attaching the porous metal material comprises sintering the porous metal material to the superior surface of the substrate.

16. The method of claim 14 wherein attaching the porous metal material comprises welding the porous metal material to the superior surface of the substrate.

17. The method of claim 14 wherein the porous metal material is titanium.

18. The method of claim 17 wherein attaching the porous metal material comprises diffusion bonding the substrate to the porous metal material.

19. The method of claim 17 wherein attaching the porous metal material comprises metallurgical bonding the substrate to the porous metal material.

20. The method of claim 14, further comprising attaching a bearing to the PEEK.
